(19) United States
(12) Patent Application Publication
(10) Pub. No.: US 2010/0144399 A1
(43) Pub. Date: Jun. 10, 2010

(54) Handsfree in-vehicle device

(75) Inventor: Takehiro Abeta, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/592,780

(22) Filed: Dec. 2, 2009

(30) Foreign Application Priority Data
Dec. 4, 2008 (JP) 2008-309652

(51) Int. Cl. H04M 1/00

(52) U.S. Cl. 455/569.2

(57) ABSTRACT

An in-vehicle device having handsfree communication function includes: a coupling element for coupling the in-vehicle device and a cell phone with a handsfree communication protocol and a mail transfer protocol, which are executed simultaneously; a status determination element for determining whether the cell phone is in a communicating state with an external phone for handsfree communication; a incoming mail determination element for determining whether an incoming mail is sent from the external phone when the cell phone receives an electronic mail; and a controller for executing a process with respect to the incoming mail without user operation when the incoming mail determination element determines that the incoming mail is sent from the external phone.

### CROSS REFERENCE TO RELATED APPLICATION

This application is based on Japanese Patent Application No. 2008-309652 filed on Dec. 4, 2008, the disclosure of which is incorporated herein by reference.

### FIELD OF THE INVENTION

The present invention relates to a handsfree in-vehicle device for performing handsfree communication protocol and mail transfer protocol simultaneously.

### BACKGROUND OF THE INVENTION

An in-vehicle device having Bluetooth communication function is disclosed in JP-A-2003-256341. Here, “Bluetooth” is a registered trademark. When a user brings a cell phone having the Bluetooth communication function in a compartment of a vehicle, on which the in-vehicle device having Bluetooth communication function is mounted, the cell phone is capable of communicating with the in-vehicle device in a Bluetooth communication manner. In this case, the cell phone transmits mail information such as a mail source, a mail incoming date, a mail subject and a mail text to the in-vehicle device. Then, the in-vehicle device displays the mail information received from the cell phone.

Here, a transfer method for transferring the mail information from the cell phone to the in-vehicle device may be performed based on a message access profile (i.e., MAP) between the cell phone and the in-vehicle device. Here, the message access profile is defined by Bluetooth communication standards. The cell phone in the compartment of the vehicle may have handsfree communication function. Thus, the handsfree communication is performed based on a handsfree profile (i.e., HFP). The handsfree profile is defined by the Bluetooth communication standards between the in-vehicle device and the cell phone. In view of the above situation, when both of the connection with the HFP and the connection with the MAP between the in-vehicle device is communicated with the cell phone can be simultaneously performed, the user may receive a mail from the other end of the phone during the handsfree call or just after the handsfree call. In this case, in general, the user may recognize a content of the mail such as mail object or the like before the user receives the mail from the other end of the phone. However, since operation of the user relating to the voice communication is independent from operation of the user relating to the mail communication, it is necessary for the user to operate the cell phone and/or the in-vehicle device in order to receive the mail even if the other end of the phone notifies the user of the content of the mail. Thus, operability of the cell phone and/or the in-vehicle device is not sufficient.

### SUMMARY OF THE INVENTION

In view of the above-described problem, it is an object of the present disclosure to provide a handsfree in-vehicle device for performing handsfree communication protocol and mail transfer protocol simultaneously with high operability.

According to a first aspect of the present disclosure, an in-vehicle device having handsfree communication function includes: a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer; a status determination element for determining whether the cell phone is in a communicating state with an external phone for handsfree communication; a incoming mail determination element for determining whether an incoming mail is sent from the external phone, which is in the communicating state with the cell phone for handsfree communication, when the cell phone receives an electronic mail; and a controller for executing a process with respect to the incoming mail without user operation when the incoming mail determination element determines that the incoming mail is sent from the external phone.

In the above device, the controller executes the process of the incoming mail without user operation when the call party sends the electronic mail during the handsfree communication. Thus, operability of the device is improved.

According to a second aspect of the present disclosure, an in-vehicle device having handsfree communication function includes: a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer; a status determination element for determining whether a time interval between an end time of handsfree communication and a present time is equal to or smaller than a predetermined time when the cell phone ends the handsfree communication with an external phone; a incoming mail determination element for determining whether an incoming mail is sent from the external phone, which ends the handsfree communication with the cell phone, when the cell phone receives an electronic mail; and a controller for executing a process with respect to the incoming mail without user operation when the incoming mail determination element determines that the incoming mail is sent from the external phone.

In the above device, the controller executes the process of the incoming mail without user operation when the call party sends the electronic mail during the handsfree communication. Thus, operability of the device is improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation system according to a first embodiment;

FIG. 2 is a diagram showing a voice communication incoming call acknowledgement image;

FIG. 3 is a diagram a handsfree communication acknowledgement image;

FIG. 4 is a flowchart showing a process executed by the navigation system;

FIG. 5 is a diagram showing mail a text acknowledgement image in a pop-up window overlapped on the handsfree communication acknowledgement image;

FIG. 6 is a diagram showing a destination setting image; and

FIG. 7 is a flowchart showing a process executed by a navigation system according to a second embodiment.

### DETAILED DESCRIPTION OF THE PREFERRED EMBODIMENTS

### First Embodiment

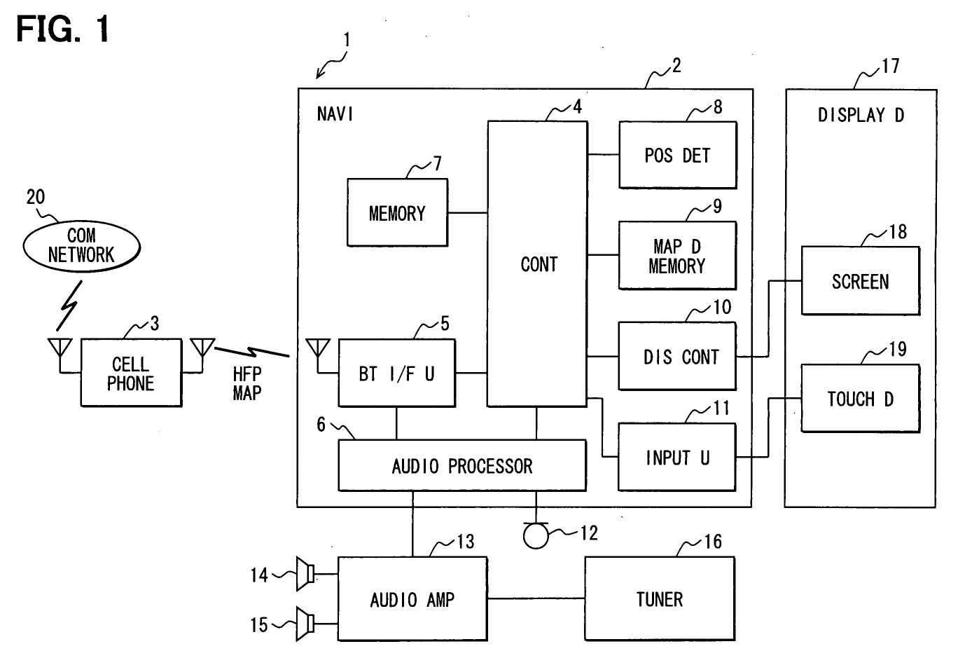

An in-vehicle device 2 having a handsfree communication function according to a first embodiment will be explained with reference to FIGS. 1-6. The handsfree communication function is performed by a Bluetooth (i.e., BT) communication function, so that the in-vehicle device 2 adapts to the BT communication method. The in-vehicle device 2 is, for example, a navigation device 2. When the navigation device 2 is mounted on a vehicle, and a user brings a cell phone 3 having the BT communication function into a compartment of the vehicle, the navigation device 2 is capable of communicating with the cell phone 3 via the BT communication method. The cell phone 3 has the BT communication function, so that the cell phone 3 adapts to the BT communication method.

A navigation system 1 includes the navigation device 2 and the cell phone 3. The navigation device 2 includes a controller 4, a BT interface (i.e., I/F) unit 5, a communication voice processor 6, a memory 7, a position detector 8, a map data memory 9, a display controller 10 and a touch operation input unit 11. The controller 4 executes a status determination function, an incoming mail determination function and a control function. The BT interface unit 5 executes connection function.

The controller 4 includes a conventional computer having a CPU, a RAM, a ROM, and an I/O bus. The controller 4 controls various operations such as communication operation and data control operation in the navigation device 2. The interface unit 5 has the BT communication function with the cell phone 3. The interface unit 5 adapts to the handsfree profile (HFP) and the message access profile (MAP). The HFP provides the handsfree communication method defined by the BT communication standards. Here, the HFP is a handsfree communication protocol. The MAP provides mail transfer function. The MAP is a mail transfer protocol. The interface unit 5 provides simultaneous connection with using both of the HFP and the MAP. The simultaneous connection is multiple connection. In addition to the HFP and the MAP, the interface unit 5 adapts to a PBAP, a OPP and the like. The PBAP is a phone book access profile for executing transfer of telephone book data, outgoing history data and incoming history data. The OPP is an object push profile for executing transfer of various data. The PBAP and the OPP are communication protocols, which are defined in each function.

The communication voice processor 6 is connected to a microphone 12, which is disposed in the compartment of the vehicle, and arranged on a predetermined position so that the microphone 12 can easily collect sound and/or voice, which is output from the user. Specifically, the microphone 12 is arranged near the steering wheel. The communication voice processor 6 is connected to an audio amplifier 13, which is disposed on an outside of the navigation device 2. The audio amplifier 13 is connected to two speakers 14, 15. The speakers 14, 15 are arranged symmetrically in a right-left direction of the vehicle with a center line along with a vehicle length direction. The speaker 14 is arranged on, for example, a driver's door, and the speaker 15 is arranged on, for example, a front passenger's door. The audio amplifier 13 is connected to a tuner deck 16. When the tuner deck 16 plays music with using memory medium for music and/or receives radio program from a radio station, the tuner deck 16 outputs the music signal and the radio program signal. Then, the audio amplifier 13 inputs the music signal and the radio program signal from the tuner deck 16, and amplifies the music signal and the radio program signal. Then, the amplified music signal and the radio program signal are output from the speakers 14, 15.

The memory 7 stores various data such as a telephone book data, an outgoing history data, an incoming history data, and the like. The telephone book data shows a relationship between a telephone number, an electric mail address and a registered name. The outgoing history data shows a relationship between an outgoing call time and an outgoing telephone number in a case where the outgoing call operation of the navigation device 2 and/or the outgoing call operation of the cell phone 3, which is connected to the navigation device 2 via the HFP, are performed. The incoming history data shows a relationship between an incoming call time and an incoming telephone number in a case where the incoming call operation of the cell phone 3, which is connected to the navigation device 2 via the HFP, is performed.

The position detector 8 includes a GPS receiver, a G sensor, a distance sensor and the like. The GPS receiver receives a GPS electric signal transmitted from a GPS satellite, and calculates various parameters. The G sensor detects acceleration of the vehicle. The distance sensor detects a driving distance. Based on the calculated result of the GPS receiver and the detection results of the G sensor and the distance sensor, a current position of the vehicle is detected. A position data showing the current position is input into the controller 4. The map data memory 9 stores a map data including a road data and an intersection data. The road data represents a setting status and the number of lanes of a road. The intersection data represents a position and a shape of an intersection.

The display device 17 includes a display screen 18 for displaying various images and a touch operation input device 19 having a touch switch on the screen 18. When a display instruction is input into the display controller 10 from the controller 4, the display controller 10 controls display operation of the screen 18 in the display device 17 based on the display instruction. When the user operates the touch switch on the screen 18 so that operation detection action as an operation detection signal is input from the touch operation input device 19 into the touch operation input unit 11, the touch operation input unit 11 inputs the operation detection signal to the controller 4. Then, the controller 4 analyzes the operation detection signal input from the touch operation input unit 11.

The controller 4 has a conventional navigation function, which includes various functions. For example, the controller 4 displays a map defined by the map data read out from the map data memory 9, and superimposes a current position mark on the mad. The current position mark corresponds to the current position of the vehicle, which is defined by a position data input from the position detector 8. Further, the controller 4 alerts a driver of the vehicle when the vehicle approaches an intersection. The controller 4 sets a destination when a user operates the touch operation input unit 11 so that the destination is set to a certain point, which is defined by a condition such as a name of the point or a telephone number of the point input by the user. The controller 4 executes to search an optimum route from the current position to the destination. The controller 4 guides the optimum route according to the searched route.

The cell phone 3 includes a control unit, a telephone communication unit, a BT interface unit, a key input unit, a memory unit, a display unit, a microphone, and a speaker. The control unit totally controls operations of the cell phone. The telephone communication unit communicates with a communication network 20 over telephone communication. The BT interface unit executes BT communication. The key input unit includes various keys, which is operable by the user. The memory unit stores various data such as a telephone book data representing a relationship between a telephone number, an electric mail address and a registered name. The display unit displays various images. The user inputs a voice message through the microphone. The speaker outputs a voice as a receipt voice message, which is received from the other end of the cell phone 3. In this case, the BT interface unit of the cell phone 3 has a BT communication function for communicating with the navigation device 2. Similar to the BT interface unit 5 of the navigation device 2, the BT interface unit of the cell phone 3 adapts to the HFP and the MAP. Thus, the cell phone 3 can perform simultaneous connection with using the HFP and the MAP with the navigation device 2. The cell phone 3 further includes a GPS receiver so that the cell phone 3 has a function for detecting a current position of the cell phone 3 and a function for transmitting a current position data toward an external device via the BT interface unit when the user operates the cell phone 3. The current position data represents the current position of the cell phone 3.

When the cell phone 3 and the navigation device 2 are connected to each other with the HFP, an incoming call to the cell phone 3 may occur via the communication network 20. Here, the communication network 20 may include a conventional cell phone communication service system having a cell phone station, a controller in the cell phone station and the like.

When the cell phone 3 is connected to the navigation device 2 with the HFP, and the cell phone 3 detects the incoming call from the communication network 20, the cell phone 3 transmits a voice communication incoming call acknowledgement to the navigation device 2. The voice communication incoming call acknowledgement represents the voice communication incoming call received by the cell phone 3. In this case, the cell phone 3 transmits the voice communication incoming call acknowledgement including identification information for identifying the cell phone 3. The identification information is, for example, a telephone number of the cell phone 3. When the cell phone 3 receives information about a telephone number of the other end of the line via the communication network 20, the cell phone 3 transmits the voice communication incoming call acknowledgement including the information about the telephone number of the other end of the line. Further, when the cell phone 3 adapts to an in-band ring tone, the cell phone transmits information about voice communication incoming call acknowledgement sound registered in the cell phone 3.

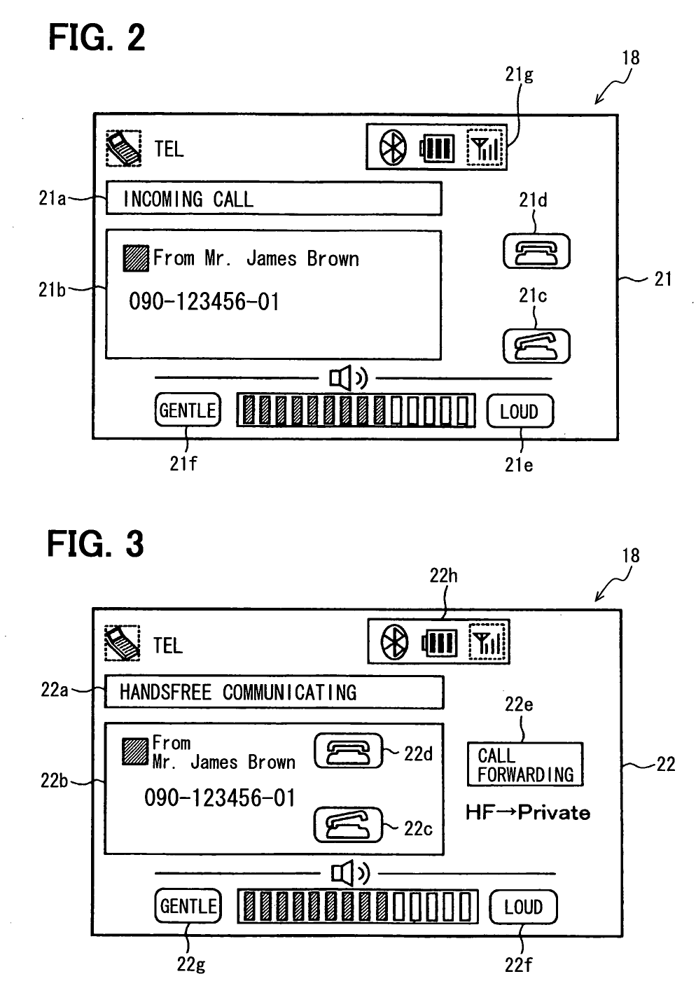

In the navigation device 2, when the device 2 receives the voice communication incoming call acknowledgement from the cell phone 3 via the BT interface unit 5, and does not receives the voice communication incoming call acknowledgement sound from the cell phone 3, the controller 4 controls the speakers 14, 15 to output the voice communication incoming call acknowledgement sound, which is registered in the device 2. Thus, the device 2 informs the user of the voice communication incoming call of the cell phone 3. When the device 2 receives the voice communication incoming call acknowledgement from the cell phone 3 via the BT interface unit 5, and further receives the voice communication incoming call acknowledgement sound from the cell phone 3, the controller 4 controls the speakers 14, 15 to output the voice communication incoming call acknowledgement sound, which is registered in the cell phone 3 and received by the device 2. The controller 4 controls the display device 17 to display an image 21 on the screen 18. The image 21 is shown in FIG. 2, and defined as a voice communication incoming call acknowledgement image representing the voice communication incoming call of the cell phone 3.

Thus, the user listens to the voice communication incoming call acknowledgement sound output from the speakers 14, 15, and/or the user watches the voice communication incoming call acknowledgement image 21 displayed on the screen 18, so that the user recognizes the voice communication incoming call of the cell phone 3. When the user acknowledges the voice communication incoming call of the cell phone 3, the user can choose whether the user responds to the incoming call in the handsfree communication manner by operating the device 2. Specifically, the user operates the navigation device 2 so that the user chooses to respond to the incoming call in the handsfree communication manner or to refuse the response. Further, when the user acknowledges the voice communication incoming call of the cell phone 3, the user can choose whether the user responds to the incoming call with handset communication by operating the cell phone 3. Specifically, the user operates the cell phone 3 so that the user chooses to respond to the incoming call with the handset communication or to refuse the response. Here, the handset communication corresponds to private communication for handling the cell phone with a hand. Here, the handsfree communication means such that a voice communication path is formed between the cell phone 3 and the navigation device 2 so that voice and/or sound signal is transmitted and received between the cell phone 3 and the navigation device 2, and thereby, the user communicates with the other end of the line with using the microphone 12 and the speakers 14, 15, which are connected to the navigation device 2. The handset communication means such that a voice communication path is closed between the cell phone 3 and the navigation device 2 so that voice and/or sound signal is not transmitted and received between the cell phone 3 and the navigation device 2, and thereby, the user communicates with the other end of the line with using the microphone and the speaker of the cell phone 3.

FIG. 2 shows a case where the device 2 receives the information about the telephone number of the other end of the line from the cell phone 3, which receives the incoming call via the communication network 20. The telephone number of the other end of the line is “090-123456-01.” The device 2 stores the telephone book data of “MR. JAMES BROWN” corresponding to the telephone number of the other end of the line is “090-123456-01.” Here, the data of “MR. JAMES BROWN” is a registered name corresponding to the telephone number. The controller 4 controls the display device 17 to display the message of “INCOMING CALL” on a status display region 21a in the voice communication incoming call acknowledgement image 21. The message of “INCOMING CALL” represents that the cell phone receives the incoming call. Further, the controller 4 controls the display device 17 to display the message of “090-123456-01” and “MR. JAMES BROWN” on an information display region 21b for the other end of the line. The message of “090-123456-01” and “MR. JAMES BROWN” represents the information about the other end of the line.

Further, the controller 4 controls the display device 17 to display a response accept switch 21c, a response refusal switch 21d, a volume up switch 21e, and a volume down switch 21f. The user operates the response accept switch 21c when the user responds to the incoming call. The user operates the response refusal switch 21d when the user refuses to respond to the incoming call. The user operates the volume up switch 21c when the user requests to increase the volume of the speakers 14, 15 so that magnitude of the voice communication incoming call acknowledgement sound is turned up. The user operates the volume down switch 21d when the user requests to decrease the volume of the speakers 14, 15 so that magnitude of the voice communication incoming call acknowledgement sound is turned down. Further, the controller 4 controls the display device 17 to display a residual amount icon and a radio wave reception status icon on a cell phone communication status display region 21g. The cell phone 3 sends information to the device 2, the information about a residual amount of electric power of a battery on the cell phone 3. The residual amount icon represents the residual amount of electric power. The radio wave reception status icon represents reception status of the radio wave.

When the cell phone 3 is in a voice communication incoming call state, the user operates the response accept switch 21c in the voice communication incoming call acknowledgement image 21 so that the user responds to the incoming call of the cell phone 3 in the handsfree communication manner. When the cell phone 3 is in a voice communication incoming call state, the user operates the response refusal switch 21d in the voice communication incoming call acknowledgement image 21 so that the user refuses to respond to the incoming call of the cell phone 3. When the cell phone 3 is in a voice communication incoming call state, the user operates a response button of the cell phone 3 so that the user responds to the incoming call of the cell phone 3 with the private communication. When the cell phone 3 is in a voice communication incoming call state, the user operates a response refusal button of the cell phone 3 so that the user refuses to respond to the incoming call of the cell phone 3.

FIG. 3 shows a case where the user operates the response accept switch 21c on the voice communication incoming call acknowledgement image 21 so that the user responds to the incoming call of the cell phone 3 in the handsfree communication manner. When the controller 4 determines that the user operates the response accept switch 21c on the image 21, the controller 4 executes response operation of the cell phone 3 according to the incoming call. Further, the controller 4 produces a voice communication path between the BT interface unit 5 and the cell phone 3. Further, the controller controls the display device 17 to switch the voice communication incoming call acknowledgement image 21 to a handsfree communication acknowledgement image 22 after the cell phone 3 switches from a voice communication incoming call state to a handsfree communication state. The handsfree communication acknowledgement image 22 is shown in FIG. 3, and represents the handsfree communication.

In the handsfree communication acknowledgement image 22, the controller 4 controls the display device 17 to display the message of “HANDSFREE COMMUNICATING” on a status display region 22a. The message of “HANDSFREE COMMUNICATING” represents that the user is communicating with the other end of the line in the handsfree communication manner. Further, the controller 4 controls the display device 17 to display the message of “090-123456-01” and “MR. JAMES BROWN” on an information display region 22b for the other end of the line. The message of “090-123456-01” and “MR. JAMES BROWN” represents the information about the other end of the line. Further, the controller 4 controls the display device 17 to display a communication holding switch 22c, a communication breaking switch 22d, a call transfer switch 22e, a volume up switch 22f, and a volume down switch 22g. The user operates the communication holding switch 22c so that the user holds the handsfree communication line. The user operates the communication breaking switch 22d so that the user breaks the handsfree communication line. The user operates the call transfer switch 22e so that the handsfree communication is switched to the private communication. The user operates the volume up switch 22f when the user requests to increase the volume of the speakers 14, 15 so that magnitude of the voice communication incoming call acknowledgement sound is turned up. The user operates the volume down switch 22g when the user requests to decrease the volume of the speakers 14, so that magnitude of the voice communication incoming call acknowledgement sound is turned down. Further, the controller 4 controls the display device 17 to display a residual amount icon and a radio wave reception status icon on a cell phone communication status display region 22h. The cell phone 3 sends information to the device 2, the information about a residual amount of electric power of a battery on the cell phone 3. The residual amount icon represents the residual amount of electric power. The radio wave reception status icon represents reception status of the radio wave.

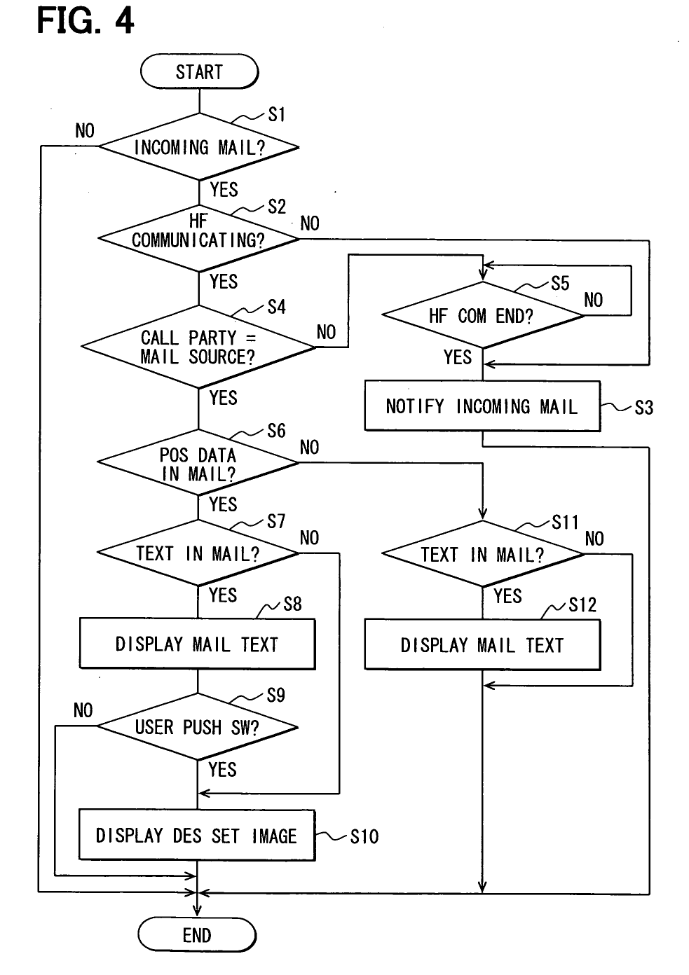

Next, the functions of the above device 2 and the cell phone 3 will be explained with respect to FIGS. 4-6. FIG. 4 shows a flowchart of a process executed by the navigation device 2. In the navigation device 2, in Step S1, when the controller 4 starts to execute an incoming mail detection process, the controller 4 determines whether an incoming mail is received by the cell phone 3 via the communication network 20. The incoming mail detection process provides to determine whether the incoming mail to the cell phone 3 via the communication network 20 occurs. When the controller 4 determines that the incoming mail to the cell phone 3 via the communication network 20 does not occur, i.e., when the determination of Step S1 is “NO,” the incoming mail detection process ends, and the controller 4 executes other process such as a main process.

When the cell phone 3 inputs the incoming mail acknowledgement into the controller 4, the controller 4 determines that the incoming mail to the cell phone 3 via the communication network 20 occurs. In this case, i.e., when the determination of Step S1 is “YES,” it goes to Step S2. In Step S2, the controller 4 determines whether the cell phone 3 is communicating in the handsfree communication manner with the other end of the line.

When the cell phone 3 inputs status acknowledgement into the controller 4, the controller determines that the cell phone 3 is not communicating with the other end of the line in the handsfree communication state. In this case, i.e., when the determination of Step S2 is “NO,” the controller 4 controls the display device 17 to display the incoming mail acknowledgement image showing the incoming mail. Further, the controller 4 simultaneously controls the speakers 14, 15 to output the incoming mail acknowledgement sound showing the incoming mail. Thus, the device 2 notifies the user of the incoming mail in Step S3.

When the cell phone 3 inputs status acknowledgement into the controller 4, the controller determines that the cell phone 3 is communicating with the other end of the line in the handsfree communication state. In this case, i.e., when the determination of Step S2 is “YES,” it goes to Step S4. In Step S4, the controller 4 refers to the telephone book, and determines whether a registered name corresponding to the telephone number of the other end of the line of the handsfree communication is the same as a registered name corresponding to the mail address of the mail source of the incoming mail. The controller 4 determines whether the telephone number of the call party as the other end of the line is the same as the telephone number of the mail source when the telephone number is used as the mail address, so that the controller 4 determines whether the electronic mail is sent from the call party.

When the controller 4 determines that the registered name corresponding to the telephone number of the call party of the handsfree communication is different from the registered name corresponding to the mail address of the mail source, and the controller 4 determines that the incoming mail is not sent by the call party of the handsfree communication, i.e., when the determination in Step S4 is“NO,” it goes to Step S5. In Step S5, the controller 4 determines whether the handsfree communication ends. When the controller 4 determines that the handsfree communication ends, i.e., when the determination in Step S5 is “YES,” it goes to Step S3. In Step S3, the controller 4 controls the display 18 to display the incoming mail acknowledgement image showing the arrival of the mail. Further, the controller 4 controls the speakers 14, 15 to output the incoming mail acknowledgement sound indicating the arrival of the mail. Thus, the controller 4 notifies the user of the arrival of the electronic mail.

When the controller 4 determines that the registered name corresponding to the telephone number of the call party of the handsfree communication is the same as the registered name corresponding to the mail address of the mail source, and the controller 4 determines that the incoming mail is sent by the call party of the handsfree communication, i.e., when the determination in Step S4 is “YES,” it goes to Step S6. In Step S6, the controller 4 analyzes the contents of the mail transmitted from the communication network 20 to the cell phone 3, and determines whether the contents of the mail include information about the position data. When the controller 4 determines that the contents of the mail include information about the position data, i.e., when the determination in Step S6 is “YES,” it goes to Step S7. In Step S7, the controller 4 determines whether the contents of the mail include a mail text.

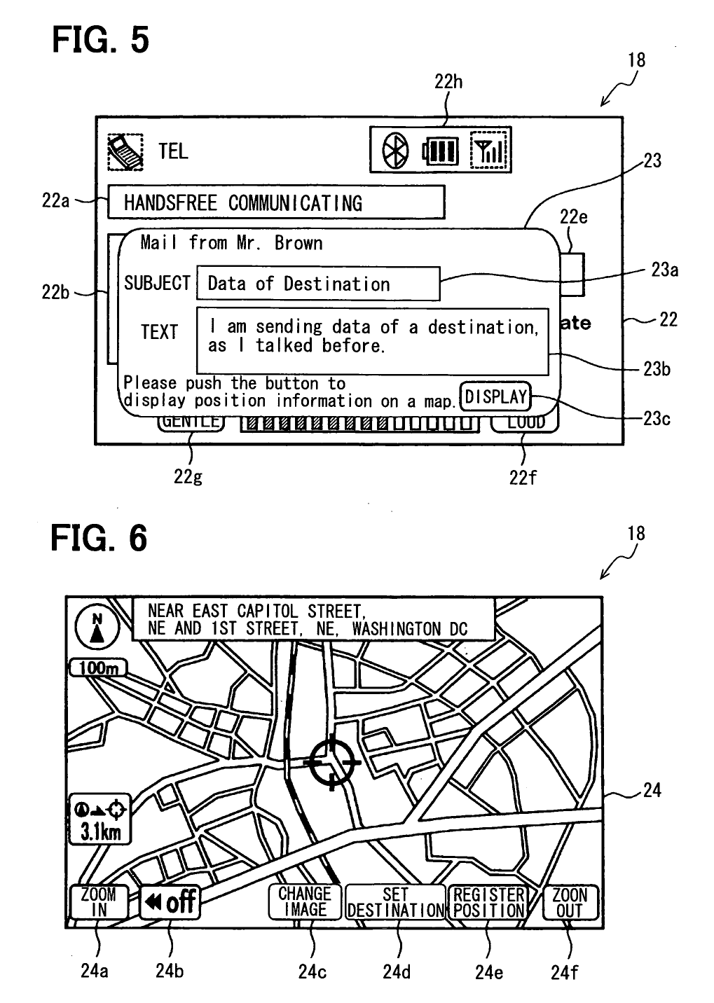

When the controller 4 determines that the contents of the mail include a mail text, i.e., when the determination in Step S7 is “YES,” it goes to Step S8. In Step S8, the controller 4 controls the display 18 to display the mail text acknowledgement image 23 in a pop-up window on the handsfree communication acknowledgement image 22. FIG. 5 shows the mail text acknowledgement image 23 in the pop-up window, and the mail text acknowledgement image 23 is overlapped on the handsfree communication acknowledgement image 22. In the mail text acknowledgement image 23, the mail subject is displayed in the subject display region 23a, and the mail text is displayed in the text display region 23b. Further, a display switch 23c as a map display operation switch is shown in the mail text acknowledgement image 23. The display switch 23c as a touch switch provides to display a map around a point corresponding to the position data, which is transmitted from the cell phone 3.

In Step S9, the controller 4 determines whether the user operates, i.e., pushes the display switch 23c in the mail text acknowledgement image 23. When the controller 4 determines that the user operates the display switch 23c, i.e., the determination in Step S9 is “YES,” it goes to Step S10. In step S10, the controller 4 controls the display 18 to display a destination setting image 24. The destination setting image 24 is shown in FIG. 6. In the destination setting image 24, the map image is displayed around the point corresponding to the position data transmitted from the cell phone 3 as a center. Further, the destination setting image 24 provides to inquiry for the user whether the point corresponding to the position data is set to be the destination.

In the destination setting image 24, a zoom-in switch 24a, an off switch 24b, a display change switch 24c, a destination setting switch 24d, a point registering switch 24e and a zoom-out switch 24f are shown. The zoom-in switch 24a functions to enlarge the map image so that a narrow area is displayed. The off switch 24b functions to turn off various touch switches. The display change switch 24c functions to change the map image. The destination setting switch 24d functions to set the point to be the destination, the point being marked at the center of the destination setting image 24. The point registering switch 24e functions to register the point marked at the center of the destination setting image 24. The zoom-out switch 24f functions to reduce the map image so that a broad area is displayed. Thus, when the user operates the destination setting switch 24d in the destination setting image 24, the point corresponding to the position data transmitted from the cell phone 3 is set to be the destination. Then, when the user operates a route guidance switch (not shown) for starting route guidance, the device guides a route from the current position to the set destination.

When the controller 4 determines that the contents of the mail do not include information about the position data, i.e., when the determination in Step S6 is “NO,” it goes to Step S11. In Step S11, the controller 4 determines whether the contents of the mail include a mail text. When the controller 4 determines that the contents of the mail include a mail text, i.e., when the determination in Step S11 is “YES,” it goes to Step S12. In Step S12, the controller 4 controls the display 18 to display the mail text acknowledgement image in a pop-up window on the handsfree communication acknowledgement image 22. In this case, the mail text acknowledgement image includes the information about the mail subject and mail text. However, the mail text acknowledgement image does not include the display switch 23c.

Thus, in the in-vehicle handsfree device 2, when the device 2 is coupled with the cell phone 3 with the HFP manner and the MAP manner, and the cell phone 3 communicating in the handsfree manner receives an electronic mail, the device 2 determines whether the incoming mail is transmitted from the call party of the handsfree communication. When the mail is transmitted from the call party, the mail text is displayed without operating by the user. Thus, the user can read the mail text easily, and thereby, the operability of the user is improved. Further, when the contents of the mail include the information about the position data, the user can choose easily whether the device 2 displays the map around the position corresponding to the position data transmitted from the cell phone 3 since the display switch 23c is arranged in the mail text acknowledgement image 23 without user operation. The display switch 23c functions to display the map around the point corresponding to the position data transmitted from the cell phone 3.

### Second Embodiment

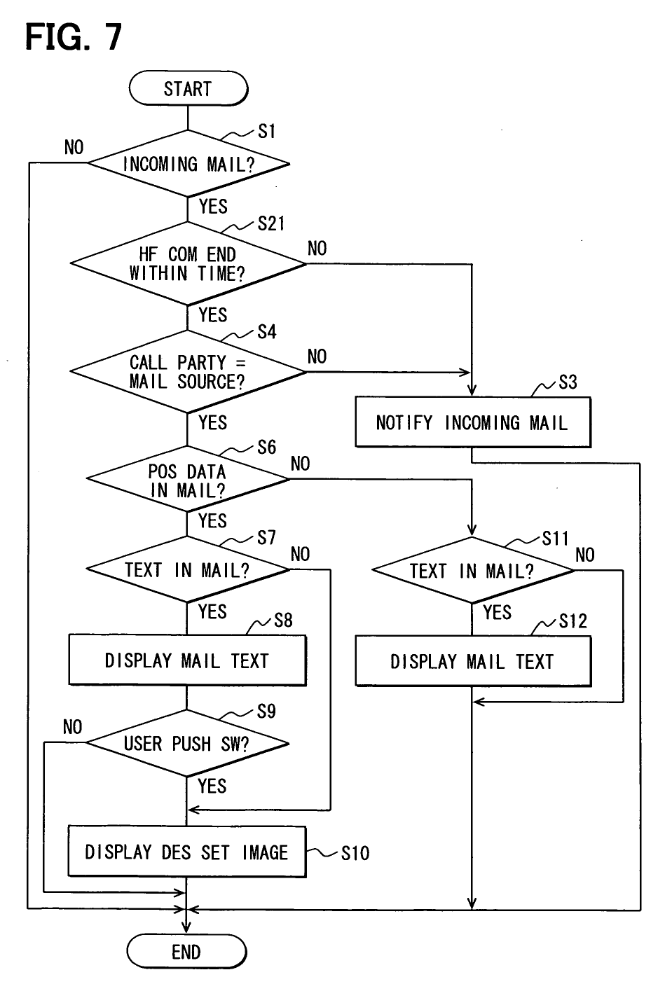

An in-vehicle device 2 having a handsfree communication function according to a second embodiment will be explained with reference to FIG. 7. In the first embodiment, the device 2 determines whether the cell phone 3 that has received the electronic mail is in the handsfree communication state when the cell phone 3 has received the incoming mail from the communication network 20. In the second embodiment, the device 2 determines whether the handsfree communication executed by the cell phone 3 that receives the electronic mail ended within a predetermined time when the cell phone 3 has received the incoming mail from the communication network 20. Specifically, the device 2 determines whether time interval between the end time of the handsfree communication and the present time is equal to or smaller than the predetermined time.

Thus, in Step S1, when the cell phone 3 inputs the incoming mail acknowledgement into the controller 4, the controller 4 determines that the incoming mail to the cell phone 3 via the communication network 20 occurs. In this case, i.e., when the determination of Step S1 is “YES,” it goes to Step S21. In Step S21, the controller 4 determines based on status acknowledgement received from the cell phone 3 whether the handsfree communication of the cell phone 3 receiving the electronic mail ended within a predetermined time. Here, the predetermined time may be settable by the user. Alternatively, the predetermined time may be a fixed time.

When the controller 4 determines based on status acknowledgement received from the cell phone 3 that the handsfree communication of the cell phone 3 receiving the electronic mail did not end within the predetermined time, i.e., when the controller 4 determines that the time interval between the end time of the handsfree communication and the present time is larger than the predetermined time, the determination in Step S21 is“NO.” In this case, it goes to Step S3. In Step S3, the controller 4 controls the display device 17 to display the incoming mail acknowledgement image showing the incoming mail. Further, the controller 4 simultaneously controls the speakers 14, 15 to output the incoming mail acknowledgement sound showing the incoming mail. Thus, the device 2 notifies the user of the incoming mail in Step S3.

When the controller 4 determines based on status acknowledgement received from the cell phone 3 that the handsfree communication of the cell phone 3 receiving the electronic mail ended within the predetermined time, i.e., when the controller 4 determines that the time interval between the end time of the handsfree communication and the present time is equal to or smaller than the predetermined time, the determination in Step S21 is “YES.” In this case, it goes to Step S4. In step S4, the controller 4 refers to the telephone book, and determines whether a registered name corresponding to the telephone number of the other end of the line of the handsfree communication is the same as a registered name corresponding to the mail address of the mail source of the incoming mail. Thus, the controller 4 determines whether the electronic mail is sent from the call party.

When the controller 4 determines in Step S4 that the registered name corresponding to the telephone number of the call party of the handsfree communication is different from the registered name corresponding to the mail address of the mail source, and the controller 4 determines that the incoming mail is not sent by the call party of the handsfree communication, i.e., when the determination in Step S4 is “NO,” it goes to Step S3 without determining whether the handsfree communication ends. In Step S3, the controller 4 controls the display device 17 to display the incoming mail acknowledgement image showing the incoming mail. Further, the controller 4 simultaneously controls the speakers 14, 15 to output the incoming mail acknowledgement sound showing the incoming mail. Thus, the device 2 notifies the user of the incoming mail in Step S3.

Thus, in the second embodiment, in the in-vehicle handsfree device 2, when the device 2 is coupled with the cell phone 3 with the HFP manner and the MAP manner, and the cell phone 3 ending the handsfree communication within a predetermined time receives an electronic mail, the device 2 determines whether the incoming mail is transmitted from the call party of the handsfree communication. When the mail is transmitted from the call party, the mail text is displayed without operating by the user. Thus, the user can read the mail text easily, and thereby, the operability of the user is improved.

(Modifications)

Although the device 2 displays the map image around the point corresponding to the position data transmitted from the cell phone 3, the device 2 may use temperature data transmitted from the cell phone 3 for setting an air conditioner. Alternatively, the device 2 may use body size data transmitted from the cell phone 3 for setting a seat position of the vehicle. In these cases, the in-vehicle device may not be the in-vehicle navigation device having the handsfree communication function. Alternatively, the in-vehicle device may be merely a device for setting a condition of the air conditioner, or a device for setting the seat position.

The above disclosure has the following aspects.

According to a first aspect of the present disclosure, an in-vehicle device having handsfree communication function includes: a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer; a status determination element for determining whether the cell phone is in a communicating state with an external phone for handsfree communication; a incoming mail determination element for determining whether an incoming mail is sent from the external phone, which is in the communicating state with the cell phone for handsfree communication, when the cell phone receives an electronic mail; and a controller for executing a process with respect to the incoming mail without user operation when the incoming mail determination element determines that the incoming mail is sent from the external phone.

In the above device, the controller executes the process of the incoming mail without user operation when the call party sends the electronic mail during the handsfree communication. Thus, operability of the device is improved.

Alternatively, the controller may provide to display a mail text of the incoming mail in the process of the incoming mail. In this case, the user can read the mail text easily.

Alternatively, the device may further include: a map data memory for storing map data; a display for displaying a map image based on the map data; and a map display operation switch for selecting whether the display displays the map image around a point corresponding to position data, which is transmitted from the cell phone via the electronic mail. The controller provides to show the map display operation switch in the process of the incoming mail. In this case, the operability and convenience of the device is improved.

Alternatively, the in-vehicle device may further include: a memory for storing telephone book data. The telephone book data represents a relationship between a telephone number, an electric mail address and a registered name, and the incoming mail determination element determines that the incoming mail is sent from the external phone when a registered name corresponding to a telephone number of the external phone is same as a registered name corresponding to a mail address of a mail source of the incoming mail. Further, the in-vehicle device may further include: a map data memory for storing map data; a display for displaying a map image based on the map data; and a map display operation switch for selecting whether the display displays the map image around a point corresponding to a position data, which is transmitted from the cell phone via the electronic mail. The controller controls the display to display a mail text of the incoming mail in the process of the incoming mail, and the controller controls the display to display the map display operation switch together with the mail text when the electronic mail includes the position data.

According to a second aspect of the present disclosure, an in-vehicle device having handsfree communication function includes: a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer; a status determination element for determining whether a time interval between an end time of handsfree communication and a present time is equal to or smaller than a predetermined time when the cell phone ends the handsfree communication with an external phone; a incoming mail determination element for determining whether an incoming mail is sent from the external phone, which ends the handsfree communication with the cell phone, when the cell phone receives an electronic mail; and a controller for executing a process with respect to the incoming mail without user operation when the incoming mail determination element determines that the incoming mail is sent from the external phone.

In the above device, the controller executes the process of the incoming mail without user operation when the call party sends the electronic mail during the handsfree communication. Thus, operability of the device is improved.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An in-vehicle device having handsfree communication function comprising:
a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer;
a status determination element for determining whether the cell phone is in a communicating state with an external phone for handsfree communication;
a incoming mail determination element for determining whether an incoming mail is sent from the external phone, which is in the communicating state with the cell phone for handsfree communication, when the cell phone receives an electronic mail; and
a controller for executing a process with respect to the incoming mail without user operation when the incoming mail determination element determines that the incoming mail is sent from the external phone.

2. The in-vehicle device according to claim 1,
wherein the controller provides to display a mail text of the incoming mail in the process of the incoming mail.

3. The in-vehicle device according to claim 1, further comprising:
a map data memory for storing map data;
a display for displaying a map image based on the map data; and
a map display operation switch for selecting whether the display displays the map image around a point corresponding to position data, which is transmitted from the cell phone via the electronic mail,
wherein the controller provides to show the map display operation switch in the process of the incoming mail.

4. The in-vehicle device according to claim 1, further comprising:
a memory for storing telephone book data,
wherein the telephone book data represents a relationship between a telephone number, an electric mail address and a registered name, and
wherein the incoming mail determination element determines that the incoming mail is sent from the external phone when a registered name corresponding to a telephone number of the external phone is same as a registered name corresponding to a mail address of a mail source of the incoming mail.

5. The in-vehicle device according to claim 4, further comprising:
a map data memory for storing map data;
a display for displaying a map image based on the map data; and
a map display operation switch for selecting whether the display displays the map image around a point corresponding to a position data, which is transmitted from the cell phone via the electronic mail,
wherein the controller controls the display to display a mail text of the incoming mail in the process of the incoming mail, and
wherein the controller controls the display to display the map display operation switch together with the mail text when the electronic mail includes the position data.

6. An in-vehicle device having handsfree communication function comprising:
a coupling element for coupling the in-vehicle device and a cell phone with a handsfree communication protocol and a mail transfer protocol, which are executed simultaneously, wherein the handsfree communication protocol is configured to execute handsfree communication, and the mail transfer protocol is configured to execute mail transfer;
a status determination element for determining whether a time interval between an end time of handsfree communication and a present time is equal to or smaller than a predetermined time when the cell phone ends the handsfree communication with an external phone;
a incoming mail determination element for determining whether an incoming mail is sent from the external phone, which ends the handsfree communication with the cell phone, when the cell phone receives an electronic mail; and
a controller for executing a process with respect to the incoming mail without user operation when the incoming mail determination element determines that the incoming mail is sent from the external phone.

7. The in-vehicle device according to claim 6,
wherein the controller provides to display a mail text of the incoming mail in the process of the incoming mail.

8. The in-vehicle device according to claim 6, further comprising:
a map data memory for storing map data;
a display for displaying a map image based on the map data; and
a map display operation switch for selecting whether the display displays the map image around a point corresponding to a position data, which is transmitted from the cell phone via the electronic mail,
wherein the controller provides to show the map display operation switch in the process of the incoming mail.

9. The in-vehicle device according to claim 6, further comprising:
a memory for storing telephone book data,
wherein the telephone book data represents a relationship between a telephone number, an electric mail address and a registered name, and
wherein the incoming mail determination element determines that the incoming mail is sent from the external phone when a registered name corresponding to a telephone number of the external phone is same as a registered name corresponding to a mail address of a mail source of the incoming mail.

10. The in-vehicle device according to claim 9, further comprising:
a map data memory for storing map data;
a display for displaying a map image based on the map data; and
a map display operation switch for selecting whether the display displays the map image around a point corresponding to a position data, which is transmitted from the cell phone via the electronic mail,
wherein the controller controls the display to display a mail text of the incoming mail in the process of the incoming mail, and
wherein the controller controls the display to display the map display operation' switch together with the mail text when the electronic mail includes the position data.
